(19) United States
(12) Patent Application Publication
(10) Pub. No.: US 2026/0142429 A1
(43) Pub. Date: May 21, 2026

(54) CONNECTOR

(71) Applicant: Japan Aviation Electronics Industry, Limited, Tokyo (JP)

(72) Inventor: Keisuke NAKAMURA, Tokyo (JP)

(73) Assignee: Japan Aviation Electronics Industry, Limited, Tokyo (JP)

(21) Appl. No.: 19/339,686

(22) Filed: Sep. 25, 2025

(30) Foreign Application Priority Data
Nov. 19, 2024 (JP) 2024-201735

(51) Int. Cl. H01R 24/44; H01R 12/72; H01R 12/75; H01R 13/24; H01R 103/00

(52) U.S. Cl. CPC H01R 24/44; H01R 12/722; H01R 12/75; H01R 13/2407; H01R 2103/00

(57) ABSTRACT

A connector includes a contact, a holding member and a slider. The holding member defines a predetermined space opening forward and has a bottom surface defining the predetermined space from beneath. A part of the bottom surface functions as a receiving portion. A size of the predetermined space in an up-down direction is significantly larger than a thickness size of a circuit board. The contact is held by the holding member so that a contact portion is in the predetermined space. In a state where the circuit board is inserted into the predetermined space and where a signal line of the circuit board faces the contact portion, the slider is inserted between the receiving portion and the circuit board, so that the circuit board is pushed upward by resilience of the slider and that the signal line of the circuit board is connected to the contact portion of the contact.

### CROSS REFERENCE TO RELATED APPLICATIONS

This application is based on and claims priority under 35 U.S.C. § 119 to Japanese Patent Application No. JP2024-201735 filed Nov. 19, 2024, the contents of which are incorporated herein in their entirety by reference.

### BACKGROUND OF THE INVENTION

This invention relates to a connector, particularly to a connector to be connected to a circuit board.

JP 2019-29103 A (Patent Document 1) discloses an example of a connector which is connectable to a circuit board without using solder.

As shown in FIG. 24, a connector 90 described in Patent Document 1 is attached to a circuit board 94 using screws 92. The connector 90 has a contact 901, and a signal line 941 is provided on a surface of the circuit board 94. When the connector 90 is fixed to the circuit board 94 with the screws 92, the contact 901 is pressed against and connected to the signal line 441.

### SUMMARY OF THE INVENTION

It is an object of the present invention to provide a connector which can connect a contact of the connector to a connection line on a circuit board without using not only solder but also any screws.

One aspect of the present invention provides a connector to be connected to a circuit board having a signal line. The connector comprises a contact, a holding member and a slider. The contact has a contact portion on a tip thereof. The holding member defines a predetermined space opening forward in a front-rear direction and has a bottom surface defining the predetermined space from beneath in an up-down direction perpendicular to the front-rear direction. A part of the bottom surface functions as a receiving portion which receives the slider. A size of the predetermined space in the up-down direction is significantly larger than a thickness size of the circuit board. The contact is held by the holding member so that the contact portion is positioned in the predetermined space at least in part. The slider has resilience at least in part. Upon inserting the slider between the receiving portion and the circuit board in a state where the circuit board is inserted into the predetermined space and where the signal line of the circuit board faces the contact portion of the contact in the up-down direction, the circuit board is pushed upward by the resilience of the slider, thereby the signal line of the circuit board is connected to the contact portion of the contact.

In the connector of the above-mentioned aspect, the size of the predetermined space in the up-down direction is significantly larger than the thickness size of the circuit board. Accordingly, the circuit board can be easily inserted into the predetermined space. By inserting the slider between the receiving portion and the circuit board in a state where the circuit board is inserted into the predetermined space and where the signal line of the circuit board faces the contact portion of the contact in the up-down direction, the circuit board is pushed upward by the resilience of the slider. As a result, connection between the signal line of the circuit board and the contact portion of the contact is achieved. Thus, according to the above-mentioned aspect, without using solder or screws, the contact of the connector can be connected to the signal line on the circuit board.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a connector according to an embodiment of the present invention. The connector is in an initial state. A supporting member is positioned at an initial position, and a slider is positioned at a preliminary position.

FIG. 2 is a front view showing the connector of FIG. 1.

FIG. 3 is a rear view showing the connector of FIG. 1.

FIG. 4 is a plan view showing the connector of FIG. 1.

FIG. 5 is a bottom view showing the connector of FIG. 1.

FIG. 6 is a side view showing the connector of FIG. 1.

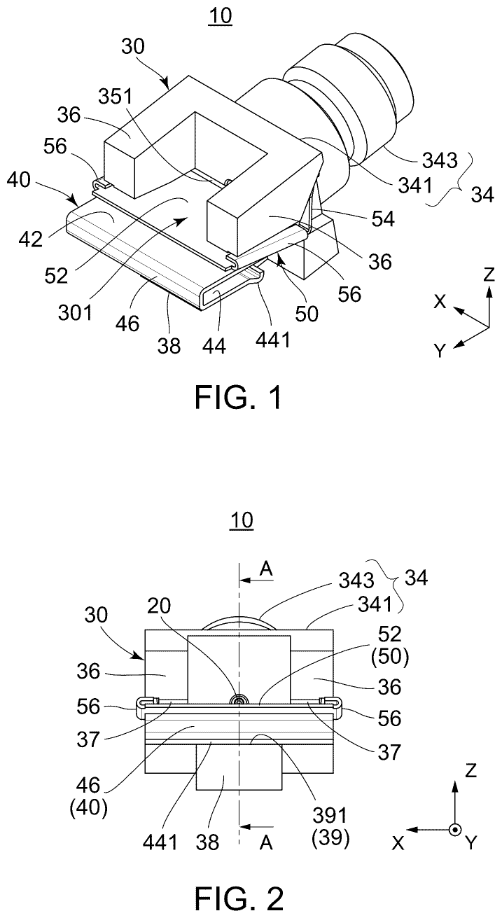

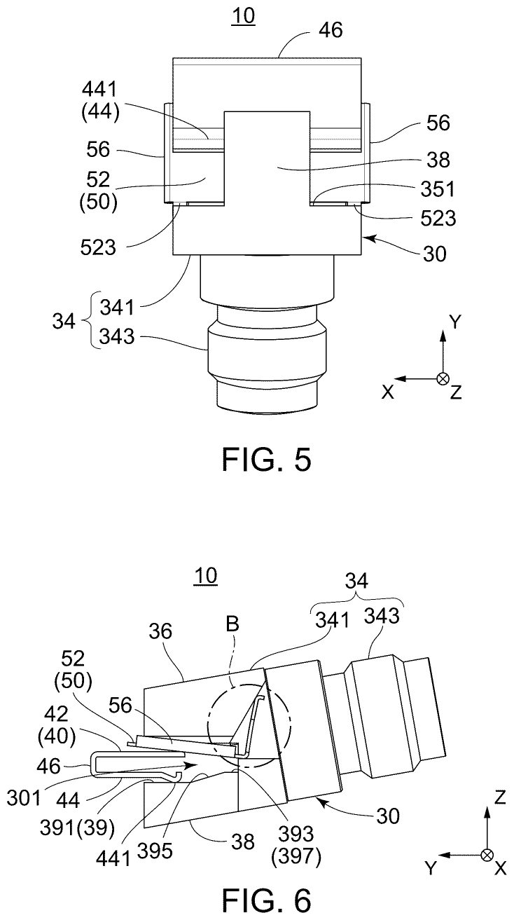

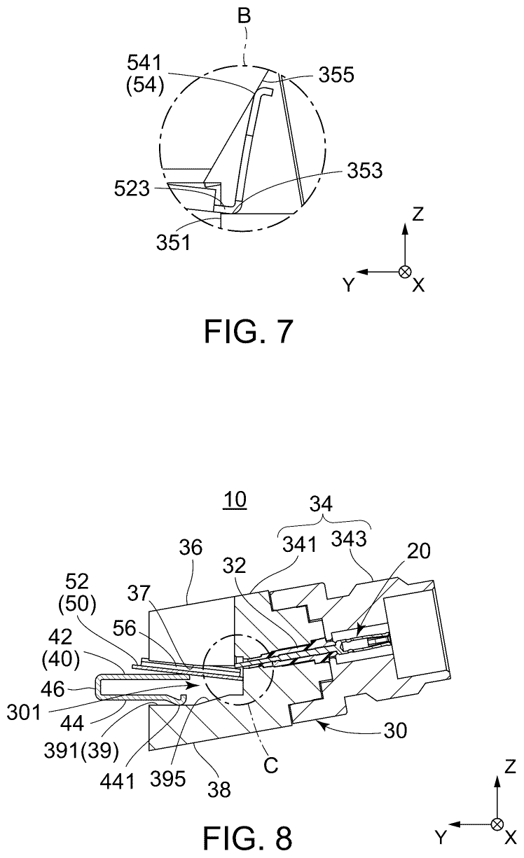

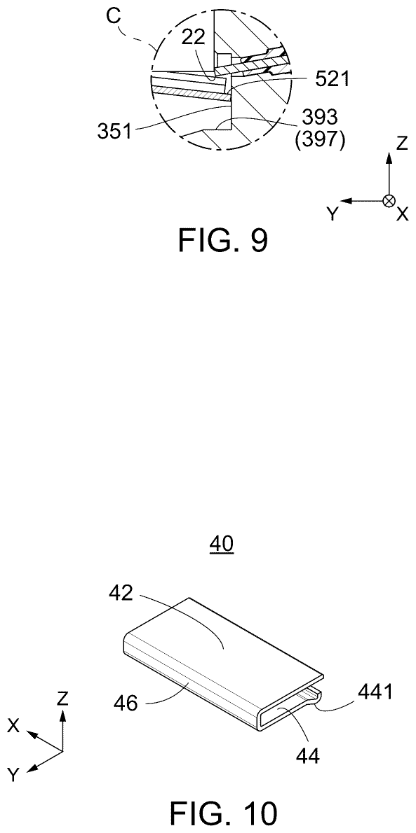

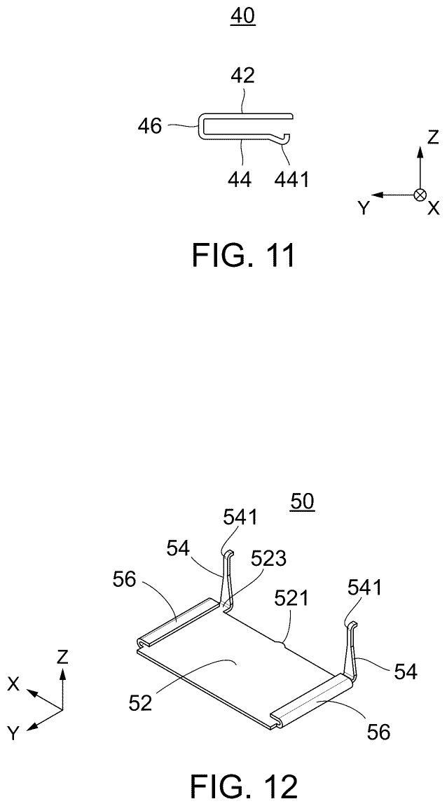

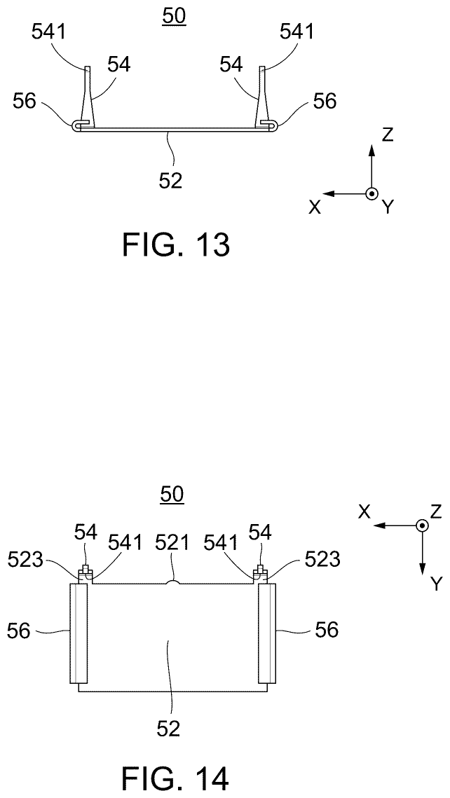

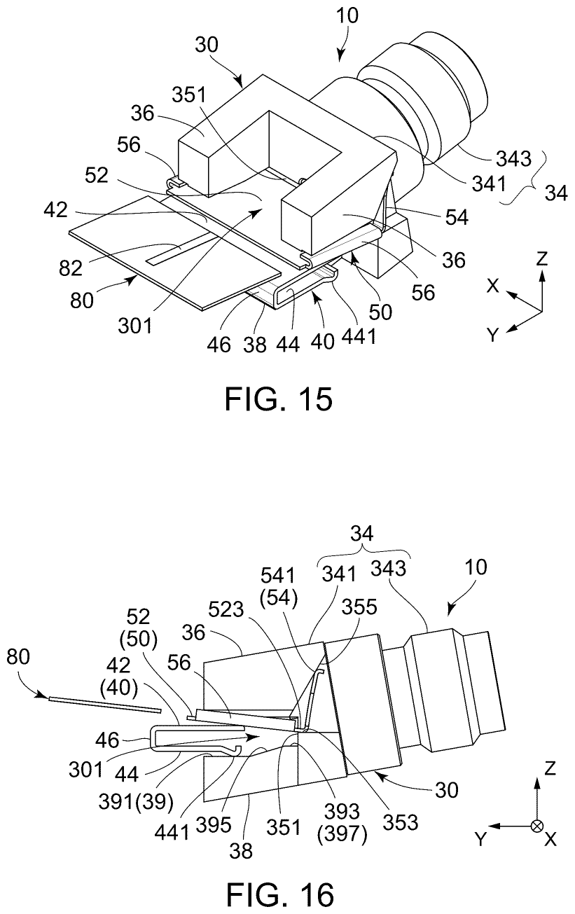

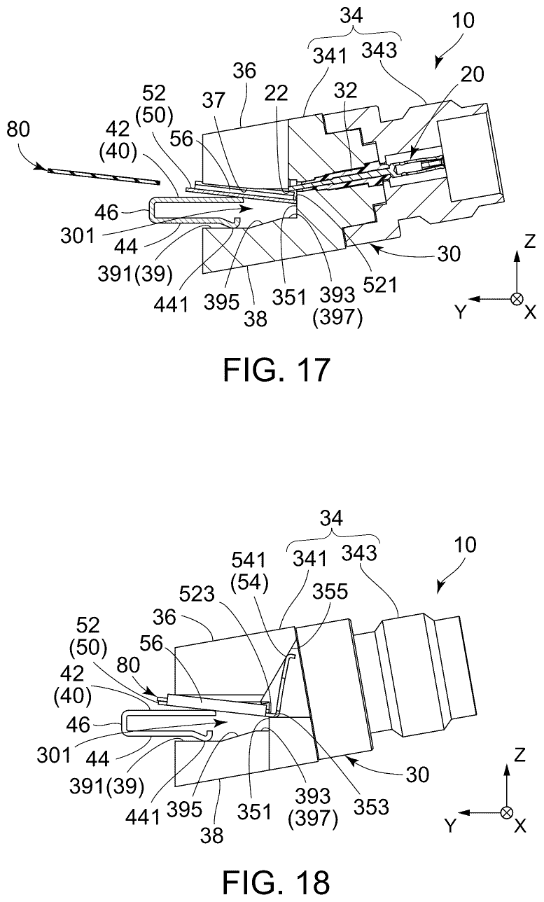

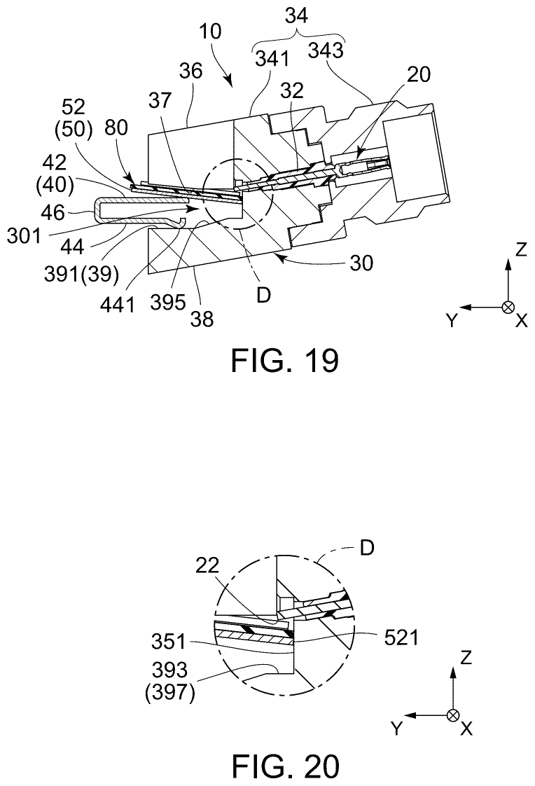

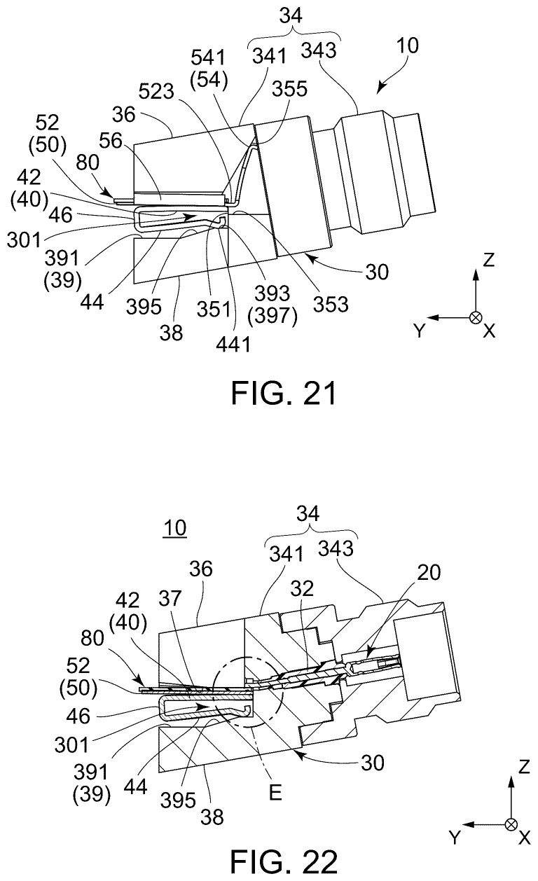

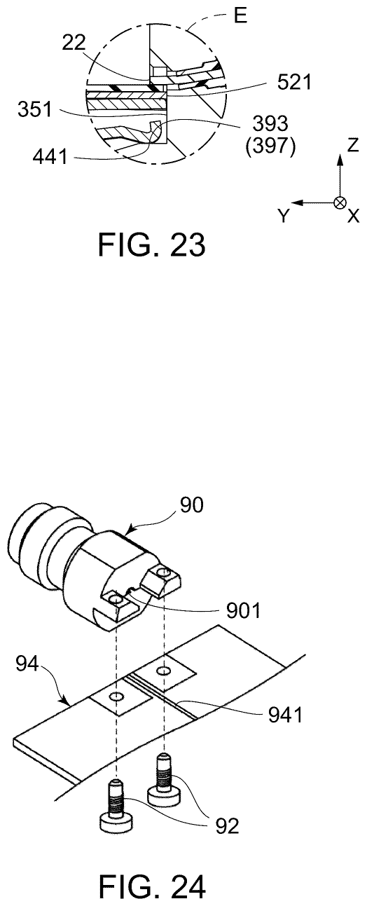

FIG. 1 is an enlarged view showing an area surrounded by a dashed line B in FIG. 6.

FIG. 2 is a cross-sectional view showing the connector of FIG. 2, taken along line A-A.

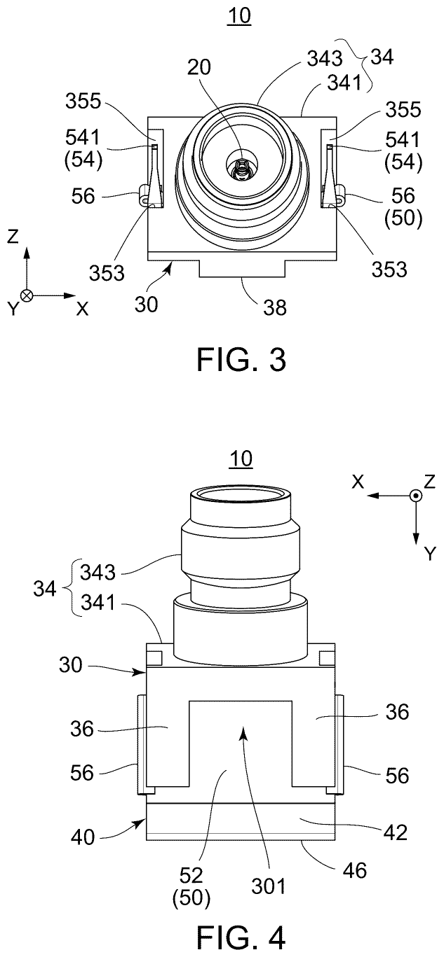

FIG. 3 is an enlarged view showing an area surrounded by a dashed line C in FIG. 8.

FIG. 4 is a perspective view showing the slider included in the connector of FIG. 1

FIG. 5 is a side view showing the slider of FIG. 10.

FIG. 6 is a perspective view showing the supporting member included in the connector of FIG. 1.

FIG. 7 is a front view showing the supporting member of FIG. 12.

FIG. 8 is a plan view showing the supporting member of FIG. 12.

FIG. 9 is a perspective view showing the connector of FIG. 1 and a circuit board connectable to the connector.

FIG. 10 is a side view showing the connector and the circuit board of FIG. 15.

FIG. 11 is a cross-sectional view showing the connector and the circuit board of FIG. 16.

FIG. 12 is another side view showing the connector and the circuit board of FIG. 15. The circuit board is inserted into a predetermined space defined by the connector. The slider is positioned at a preliminary position.

FIG. 13 is a cross-sectional view showing the connector and the circuit board of FIG. 18.

FIG. 14 is an enlarged view showing an area surrounded by a dashed line D in FIG. 19.

FIG. 15 is yet another side view showing the connector and the circuit board of FIG. 15. The circuit board is inserted into the predetermined space defined by the connector. The slider is positioned at an insertion position.

FIG. 16 is a cross-sectional view showing the connector and the circuit board of FIG. 21.

FIG. 17 is an enlarged view showing an area surrounded by a dashed line E in FIG. 22.

FIG. 18 is a perspective view showing an attaching method of attaching a coaxial connector to a circuit board described in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

Referring to FIGS. 1 to 9, a connector 10 according to an embodiment of the present invention is provided with a contact 20, a holding member 30 and a slider 40. In the present embodiment, the connector 10 is further provided with a supporting member 50. However, the present invention is not limited thereto. The connector 10 may not have the supporting member 50.

As understood from FIG. 15, the connector 10 according to the present embodiment is a connector to be connected to a circuit board 80. In the present embodiment, a signal line 82 is provided on an upper surface of the circuit board 80. In other words, the connector 10 is a connector to be connected to the circuit board 80 having the signal line 82. However, the present invention is not limited thereto. The present invention is applicable to a connector to be connected to a circuit board 80 having a plurality of signal lines 82. Moreover, in the present embodiment, the circuit board 80 is a flexible printed circuit board. However, the present invention is not limited thereto. The circuit board 80 may be a rigid printed circuit board. When the circuit board 80 is a rigid printed circuit board, the supporting member 50 may be omitted.

As understood from FIGS. 1 to 9, the connector 10 according to the present embodiment functions as a coaxial connector. The contact 20 functions as an internal conductor of the coaxial connector. However, the present invention is not limited thereto. The present invention is applicable to connectors other than the coaxial connector.

As shown in FIGS. 8 and 9, the holding member 30 is provided with an insulator 32 holding the contact 20 and a shell 34 made of metal and holding the insulator 32. In the present embodiment, the shell 34 consists of a front shell 341 and a rear shell 343. In a front-rear direction, the front shell 341 is located forward of the rear shell 343. In the present embodiment, the front-rear direction is a Y-direction. A positive Y-direction is directed forward while a negative Y-direction is directed rearward.

As shown in FIGS. 1, 2 and 4, the front shell 341 of the holding member 30 has two upper protruding portions 36. Moreover, as shown in FIGS. 2 and 5, the front shell 341 of the holding member 30 has a lower protruding portion 38. The upper protruding portions 36 and the lower protruding portion 38 protrude forward in the front-rear direction. In an up-down direction perpendicular to the front-rear direction, the upper protruding portions 36 are located apart from and upward of the lower protruding portion 38. In a lateral direction perpendicular to both the front-rear direction and the up-down direction, the upper protruding portions 36 are disposed apart from each other. In the lateral direction, the lower protruding portion 38 is disposed between the two upper protruding portions 36. In the present embodiment, the up-down direction is a Z-direction. A positive Z-direction is directed upward while a negative Z-direction is directed downward. Moreover, in the present embodiment, the lateral direction is an X-direction.

As understood from FIGS. 6 to 9, the holding member 30 defines a predetermined space 301. In detail, lower surfaces 37 of the upper protruding portions 36 define the predetermined space 301 from above in the up-down direction, and an upper surface 39 of the lower protruding portion 38 defines the predetermined space 301 from beneath in the up-down direction. The predetermined space 301 opens forward in the front-rear direction. In the present embodiment, the predetermined space 301 also opens in the lateral direction. Here, the upper surface 39 of the lower protruding portion 38 partly defines a bottom of the predetermined space 301. Accordingly, the upper surface 39 of the lower protruding portion 38 is referred to as a “bottom surface” 39 hereinafter. Thus, the holding member 30 defines the predetermined space 301 which opens forward in the front-rear direction, and it has the bottom surface 39 defining the predetermined space 301 from beneath in the up-down direction.

As shown in FIGS. 6 to 9, the bottom surface 39 of the holding member 30 has a lower surface 391 and a higher surface 393. The lower surface 391 is located downward of the higher surface 393 in the up-down direction. Moreover, the lower surface 391 is located forward of the higher surface 393 in the front-rear direction. In the present embodiment, the bottom surface 39 further has an inclined surface 395. The inclined surface 395 is located between the lower surface 391 and the higher surface 393 in the front-rear direction, and it connects the lower surface 391 to the higher surface 393.

As shown in FIGS. 8 and 9, each of the lower surfaces 37 of the upper protruding portions 36 of the holding member 30 has two flat surfaces. One of the flat surfaces is a rear flat surface perpendicular to the up-down direction. The remaining one is a front flat surface located forward of the rear flat surface in the front-rear direction and obliquely intersects with the up-down direction. However, the present invention is not limited thereto. Each of the lower surfaces 37 may consist of a single flat surface. Nevertheless, providing the front flat surface makes insertion of the circuit board 80 into the predetermined space 301 easy.

As understood from FIGS. 16 and 17, a size of the predetermined space 301 in the up-down direction is significantly larger than a thickness size of the circuit board 80. In detail, the size of the predetermined space 301 in the up-down direction is equal to or larger than a size which can accommodate at least the circuit board 80 and the slider 40. In the present embodiment, the size of the predetermined space 301 in the up-down direction is equal to or larger than a size which can accommodate a main portion 52 of the supporting member 50 in addition to the circuit board 80 and the slider 40.

Referring to FIGS. 10 and 11, the slider 40 has an upper plate 42, a lower plate 44 and a side plate 46. When viewed in the lateral direction, the slider 40 has a U-shape and opens rearward. The lower plate 44 is formed with an elongated ridge 441 which extends in the lateral direction and protrudes downward. The slider 40 has resilience at least in part and can change a distance between a rear edge of the upper plate 42 and a rear edge of the lower plate 44 in the up-down direction. The slider 40 may be formed by bending a rectangular plate made of metal, for example.

Referring to FIGS. 12 to 14, the supporting member 50 has the main portion 52 with a plate shape and two arm portions 54. The main portion 52 has a rectangular shape when viewed in the up-down direction. At both ends of the main portion 52 in the lateral direction, guide portions 56 are provided and extend in the front-rear direction. As shown in FIG. 13, each of the guide portions 56 has a U-shape which opens inward in the lateral direction when viewed in the front-rear direction.

As shown in FIG. 14, the main portion 52 is provided with a contact protruding portion 521 which protrudes rearward in the front-rear direction. The contact protruding portion 521 is located at a middle of the main portion 52 in the lateral direction and forms a rear edge of the main portion 52 in part. Furthermore, the main portion 52 has ear portions 523 protruding rearward in the front-rear direction at both end portions thereof in the lateral direction. The arm portions 54 extend upward from rear ends of the ear portions 523. However, the present invention is not limited thereto. The main portion 52 may not have the ear portions 523. Nevertheless, in that case, it is necessary to change the shape of the front shell 341 so that the shape of the front shell 341 corresponds to the shape of the main portion 52.

Referring again to FIGS. 6 to 9, in an initial state, the main portion 52 of the supporting member 50 is located almost entirely in the predetermined space 301. However, a front edge of the main portion 52 is located outside the predetermined space 301. In addition, the arm portions 54 of the supporting member 50 are located outside the predetermined space 301.

As shown in FIGS. 8 and 9, the contact protruding portion 521 of the main portion 52 comes into contact with an abutment surface 351 provided to the front shell 341 of the holding member 30. The abutment surface 351 is a surface facing forward in the predetermined space 301. The abutment surface 351 is conductive and electrically connected to the contact protruding portion 521 by contact. In the present embodiment, the shell 34 is conductive as a whole, and the supporting member 50 and the shell 34 are electrically connected to each other.

As shown in FIGS. 3, 6 and 7, in the initial state, the main portion 52 is supported by defining portions 353 of the holding member 30. In other words, the holding member 30 has the defining portions 353 which support the main portion 52 and thereby define an initial position of the main portion 52. In the present embodiment, the defining portions 353 support rear ends of the ear portions 523 of the main portion 52 or support lower ends of the arm portions 54 of the supporting member 50. The defining portions 353 are surfaces facing upward in the up-down direction and support the main portion 52 of the supporting member 50 so that the main portion 52 can move in the up-down direction. However, the whole of the main portion 52 may not be able to move upward. The main portion 52 should be supported by the defining portions 353 so that at least the rear edge thereof can be moved upward.

As understood from FIGS. 6 and 7, upper end portions of the arm portions 54 of the supporting member 50 are pressed against the holding member 30. In detail, the holding member 30 is provided with pressed surfaces 355, and the upper end portions of the arm portions 54 are provided with pressing portions 541. The pressed surfaces 355 are surfaces which obliquely intersect with both the front-rear direction and the up-down direction. By reaction forces generated by the pressing portions 541 of the arm portions 54 pressing the pressed surfaces 355, the ear portions 523 of the main portion 52 are pressed against the defining portions 353. Thus, the main portion 52 is maintained at the initial position.

As shown in FIGS. 6 to 9, in the initial state, the slider 40 is positioned at a preliminary position. In detail, the slider 40 is positioned downward of the main portion 52 of the supporting member 50 in the up-down direction and positioned in the predetermined space 301 in part. When the slider 40 is positioned at the preliminary position, the elongated ridge 441 is positioned on the lower surface 391 of the bottom surface 39. Since the lower surface 391 is located downward of the higher surface 393 in the up-down direction, the slider 40 can be easily inserted into the predetermined space 301.

As shown in FIGS. 8 and 9, in the present embodiment, the contact 20 extends straight along a direction oblique to the front-rear direction. However, the present invention is not limited thereto. In the present invention, the contact 20 may extend in parallel to the front-rear direction.

As shown in FIGS. 8 and 9, in the present embodiment, a tip of the contact 20 is located in the predetermined space 301. Here, the tip of the contact 20 functions as a contact portion 22 which comes into contact with the signal line 82 of the circuit board 80 (see FIG. 15). The contact 20 has the contact portion 22 at the tip thereof as just described, and it is held by the holding member 30 so that the contact portion 22 is located in the predetermined space 301 at least in part. In the present embodiment, the tip of the contact 20 is used as the contact portion 22, so that it can be avoided that contact accuracy of the contact portion 22 is reduced in comparison with a case where the contact portion 22 is formed by a bending process. Incidentally, even when the contact 20 extends in parallel to the front-rear direction, it is preferable that at least the tip portion of the contact 20 obliquely intersects with the front-rear direction. This is for avoiding reduction of the contact accuracy between the contact portion 22 of the contact 20 and the signal line 82 of the circuit board 80.

As understood from FIGS. 8 and 9, when the main portion 52 of the supporting member 50 is positioned in the initial position, the shortest distance between the main portion 52 and the contact portion 22 of the contact 20 is larger than a thickness size of the circuit board 80. This is for avoiding that the circuit board 80 comes into abutment with the contact portion 22 when the circuit board 80 is inserted into the predetermined space 301.

As shown in FIGS. 15 to 20, the circuit board 80 is inserted into the predetermined space 301 of the connector 10. At this time, the circuit board 80 is guided by the guide portions 56 and slides on the main portion 52 of the supporting member 50 to be inserted into the predetermined space 301. Since the circuit board 80 slides on the main portion 52 of the supporting member 50, the circuit board 80 is prevented from accidentally coming into abutment with the contact portion 22 of the contact 20. Accordingly, accidental damage to the circuit board 80 and the contact 20 is prevented. When a rear edge of the circuit board 80 comes into abutment with the abutment surface 351 of the holding member 30, a relative position of the circuit board 80 with respect to the holding member 30 is determined. At this time, the signal line 82 of the circuit board 80 faces the contact portion 22 of the contact 20 in the up-down direction.

As understood from FIGS. 21 to 23, when the slider 40 is pushed rearward in the front-rear direction after the circuit board 80 is inserted into the predetermined space 301, the slider 40 is moved from the preliminary position to an insertion position. At this time, the elongated ridge 441 of the lower plate 44 of the slider 40 is moved from the lower surface 391 onto the higher surface 393, and the slider 40 is resiliently deformed. The inclined surface 395 facilitates movement of the elongated ridge 441 from the lower surface 391 onto the higher surface 393. The resilient deformation of the slider 40 brings the rear edge of the upper plate 42 and the rear edge of the lower plate 44 closer to each other in the up-down direction. When the rear edge of the upper plate 42 of the slider 40 comes into abutment with the abutment surface 351 of the holding member 30, a relative position of the slider 40 with respect to the holding member 30 and the circuit board 80 is determined. In this state, the slider 40 pushes the circuit board 80 upward via the supporting member 50 by the use of reaction force thereof. Since the higher surface 393 is located upward of the lower surface 391 in the up-down direction, the slider 40 can generate a desired reaction force. At this time, the higher surface 393 functions as a receiving portion 397 which receives the reaction force generated by the resilience of the slider 40. Thus, the bottom surface 39 is provided with the receiving portion 397 which receives the reaction force of the slider 40. In the present embodiment, the receiving portion 397 is provided on the higher surface 393 of the bottom surface 39.

As understood from FIGS. 22 and 23, the circuit board 80 is moved upward by the reaction force of the slider 40. In the present embodiment, the circuit board 80 is not moved upward as a whole, and the rear edge of the circuit board 80 is moved upward. However, the present invention is not limited thereto. The circuit board 80 may be moved upward as a whole.

As shown in FIGS. 22 and 23, the circuit board 80 is pressed in part against the lower surfaces 37 of the upper protruding portions 36 of the holding member 30 by the reaction force of the slider 40 and fixed in position. At the same time, the signal line 82 of the circuit board 80 (see FIG. 15) is pressed against the contact portion 22 of the contact 20. Accordingly, the contact 20 and the signal line 82 are electrically connected to each other. Thus, the connector 10 is attached to the circuit board 80 without using solder or screws, and the contact 20 is connected to the signal line 82.

As described above, according to the present embodiment, in a state where the circuit board 80 is inserted into the predetermined space 301 and where the signal line 82 of the circuit board 80 faces the contact portion 22 of the contact 20 in the up-down direction, the slider 40 is inserted between the receiving portion 397 and the circuit board 80, so that the circuit board 80 is pushed upward by the reaction force of the slider 40 and that the signal line 82 of the circuit board 80 is connected to the contact portion 22 of the contact 20. In the present embodiment, insertion of the slider 40 is carried out in a state in which the circuit board 80 is supported by the supporting member 50. In other words, the slider 40 is inserted between the main portion 52 of the supporting member 50 and the receiving portion 397. However, the present invention is not limited thereto. In a case where the connector 10 does not have the supporting member 50, the slider 40 directly comes into contact with the circuit board 80 and is inserted between the receiving portion 397 and the circuit board 80.

As understood from FIG. 21, when the supporting member 50 is moved upward by the reaction force of the slider 40, the pressing portions 541 of the arm portions 54 are moved upward along the pressed surfaces 355 and moved rearward. Accordingly, the arm portions 54 are resiliently deformed. As a result, the contact protruding portion 521 of the main portion 52 is pressed against the abutment surface 351 by reaction forces generated by the pressing portions 541 pressing the pressed surfaces 355. In the present embodiment, the contact protruding portion 521 is pressed against the abutment surface 351 at a position directly under the contact 20 in view of impedance matching. A lower surface of the circuit board 80 is provided with a ground pattern (not shown), and the ground pattern comes into contact with the main portion 52 of the supporting member 50. Since the contact protruding portion 521 of the main portion 52 is pressed against the abutment surface 351, the ground pattern is electrically connected to the abutment surface 351 via the main portion 52. Accordingly, the ground pattern of the circuit board 80 is electrically connected to the shell 34. However, when the connector 10 is not a coaxial connector, the ground pattern on the lower surface of the circuit board 80 is not indispensable.

As mentioned above, the connector 10 of the present embodiment can connect the contact 20 to the signal line 82 on the circuit board 80 without using solder or screws. Furthermore, the connector 10 of the present embodiment can connect the shell 34 to the ground pattern (not shown) of the circuit board 80 without solder or screws.

Although the specific explanation about the present invention is made above with reference to concrete embodiments, the present invention is not limited thereto but susceptible of various modifications and alternative forms without departing from the spirit of the invention. For example, though two upper protruding portions 36 and one lower protruding portion 38 are used to define the predetermined space 301 in the aforementioned embodiment, one upper protruding portion 36 and one lower protruding portion 38 which face each other in the up-down direction may be used.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

1. A connector to be connected to a circuit board having a signal line, wherein:
the connector comprises a contact, a holding member and a slider;
the contact has a contact portion on a tip thereof;
the holding member defines a predetermined space opening forward in a front-rear direction and has a bottom surface defining the predetermined space from beneath in an up-down direction perpendicular to the front-rear direction;
a part of the bottom surface functions as a receiving portion which receives the slider;
a size of the predetermined space in the up-down direction is significantly larger than a thickness size of the circuit board;
the contact is held by the holding member so that the contact portion is positioned in the predetermined space at least in part;
the slider has resilience at least in part; and
upon inserting the slider between the receiving portion and the circuit board in a state where the circuit board is inserted into the predetermined space and where the signal line of the circuit board faces the contact portion of the contact in the up-down direction, the circuit board is pushed upward by the resilience of the slider, thereby the signal line of the circuit board is connected to the contact portion of the contact.

2. The connector as recited in claim 1, wherein:
the connector further comprises a supporting member;
the supporting member has a main portion with a plate shape;
the holding member has a defining portion which defines an initial position of the main portion of the supporting member;
in an initial state, the main portion is supported on the defining portion in a state where the main portion is movable upward in the up-down direction;
when the main portion is positioned at the initial position, a shortest distance between the main portion and the contact portion of the contact is larger than the thickness size of the circuit board; and
upon inserting the slider between the receiving portion and main portion of the supporting member in a state where the circuit board is inserted onto the main portion of the supporting member and where the circuit board is supported by the main portion, the circuit board is pushed upward by the resilience of the slider via the main portion of the supporting member.

3. The connector as recited in claim 2, wherein each end of the main portion in a lateral direction perpendicular to both the front-rear direction and the up-down direction is provided with a guide portion which regulates movement of the circuit board in the up-down direction and in the lateral direction and guides insertion of the circuit board.

4. The connector as recited in claim 2, wherein:
the holding member is provided with a pressed surface;
the supporting member has two arm portions having resilience and extending upward from the main portion;
each of the arm portions is provided with a pressing portion pressing the pressed surface; and
the main portion is pressed against the defining portion by a reaction force of the pressing portions of the arm portions pressing the pressed surface.

5. The connector as recited in claim 2, wherein:
the holding member is provided with a pressed surface and an abutment surface;
the abutment surface faces forward in the predetermined space and has conductivity;
the supporting member has two arm portions having resilience and extending upward from the main portion;
each of the arm portions is provided with a pressing portion pressing the pressed surface; and
upon inserting the slider between the receiving portion and the main portion of the supporting member, the main portion is pressed against the abutment surface by a reaction force of the pressing portions of the arm portions pressing the pressed surface.

6. The connector as recited in claim 5, wherein:
the main portion is provided with a contact protruding portion protruding rearward in the front-rear direction; and
upon inserting the slider between the receiving portion and the main portion of the supporting member, the contact protruding portion is pressed against the abutment surface at a position corresponding to a position directly below the contact.

7. The connector as recited in claim 1, wherein:
the bottom surface has a lower surface and a higher surface;
the lower surface is located downward of the higher surface in the up-down direction;
the lower surface is located forward of the higher surface in the front-rear direction; and
the receiving portion is provided on the higher surface.

8. The connector as recited in claim 7, wherein:
the bottom surface has an inclined surface; and
the inclined surface connects the lower surface to the higher surface.

9. The connector as recited in claim 8, wherein the slider is made of metal and formed by bending so that the slider opens rearward.

10. The connector as recited in claim 1, wherein the contact extends straight along a direction oblique to the front-rear direction.

11. The connector as recited in claim 1, wherein:
the holding member is provided with an insulator holding the contact and a shell made of metal and holding the insulator;
the contact functions as an internal conductor; and
the connector functions as a coaxial connector.
